(19) United States
(12) Patent Application Publication
(10) Pub. No.: US 2005/0027836 A1
(43) Pub. Date: Feb. 3, 2005

(54) Computing system

(76) Inventors: Akinori Nishihara, Kawasaki-shi (JP); Tetsuya Hasebe, Yokohama-shi (JP); Hiroaki Hayashi, Yokohama-shi (JP); Takashi Mita, Yokohama-shi (JP)

Correspondence Address: Mitchell P Brook;Luce Forward Hamilton & Scripps, Suite 200, 11988 EI Camino Real, San Diego, CA, 92130, US

(21) Appl. No.: 10/477,374

(22) PCT Filed: May 8, 2002
(86) PCT No.: PCT/JP02/04461

(30) Foreign Application Priority Data
May 10, 2001 (JP) 2001-139951
Mar. 6, 2002 (JP) 2002-060515

(51) Int. Cl. G06F 15/173

(52) U.S. Cl. 709/223

(57) ABSTRACT

A computing unit (42) executes a second computing in the middle of a first computing. At this time, the hardware structure of the computing unit (42) is switched in accordance with a computing which is a target of execution. A controller (46) stores the internal state of the computing unit (42) in a memory (44) when a computing to be executed by the computing unit (42) changes from the first computing to the second computing. And the controller (46) controls execution of the first computing to be continued by returning the internal state stored in the memory (44) to the computing unit (42), when a computing to be executed by the computing unit (42) returns from the second computing to the first computing.

### TECHNICAL FIELD

The present invention relates to a computing system in which hardware directly executes a computing in accordance with a program, and particularly relates to a computing system which is suitable for executing a computing in accordance with a large-scale program.

### BACKGROUND ART

In a current general-purpose computer, computing is progressed while a CPU (Central Processing Unit) sequentially interprets instructions in a program stored in a memory. A CPU is for executing a computing which is a target of execution, by means of software. Thus, the hardware structure of a CPU is not necessarily the most suitable for a computing which is a target of execution. As a result, there is incurred a lot of overhead until the final computing result is obtained.

In contrast, as a technique for executing a computing represented by a program directly by hardware, a computing system utilizing a field programmable gate array (FPGA) has been known. National Publication No. H8-504285 (International Publication No. WO94/10627) and National Publication No. 2000-516418 (International Publication No. WO98/08306) disclose a computing system utilizing an FPGA.

The hardware structure of an FPGA is changeable by logic data. By utilizing such an FPGA, hardware can directly execute a computing represented by a program. Therefore, a computing result can be obtained at higher speed than in a case where a CPU executes a computing.

On the other hand, a large-scale program executed by a current general-purpose computer consists of a plurality of program modules. A computing represented by a large-scale program is progressed while a program module calls another program module.

However, the above described conventional computing systems utilizing an FPGA can only execute a computing represented by a program consisting of substantially one program module. In other words, the conventional computing systems utilizing an FPGA cannot execute a large-scale computing represented by a large-scale program consisting of a plurality of program modules. Therefore, there is a problem that conventional computing systems utilizing an FPGA cannot be applied in various ways.

The disclosures of National Publication No. H8-504285 (International Publication No. WO94/10627) and National Publication No. 2000-516418 (International Publication No. WO98/08306) are incorporated herein by reference.

### DISCLOSURE OF INVENTION

The present invention was made to overcome the problem of the above described prior art, and it is an object of the present invention to provide a computing system in which hardware can directly execute a computing represented by a large-scale program consisting of a plurality of program modules.

To accomplish the above object, a computing system according to a first aspect of the present invention comprises:
a computing unit (42) which has a hardware structure corresponding to a computing which is a target of execution, and executes the computing which is the target of execution;
a state memory (44) which stores an internal state of the computing unit; and
a controller (46, 46′) which controls the internal state of the computing unit,
wherein: the computing unit (42) executes a second computing in the middle of a first computing; and
the controller (46, 46′) stores the internal state in the state memory (44) when a computing to be executed by the computing unit (42) switches from the first computing to the second computing, and controls the computing unit (42) to resume execution of the first computing by returning the internal state stored in the state memory (44) to the computing unit (42) when a computing to be executed by the computing unit (42) returns from the second computing to the first computing.

According to this invention, a computing represented by a large-scale program consisting of a plurality of program modules can be executed directly by hardware, without using a general-purpose CPU.

The state memory (44) may store the internal state in accordance with a First-In-Last-Out method.

The computing unit (42) may comprise a plurality of gate circuits.

Connection between the plurality of gate circuits may be switched in accordance with a computing which is a target of execution.

A computing system according to a second aspect of the present invention comprises:
a loader (3) which loads a plurality of data modules by each module, each of the plurality of data modules representing a hardware structure which is suitable for executing a predetermined computing;
a computing unit (42) which has a hardware structure changeable in accordance with a hardware structure represented by a loaded data module, and executes a predetermined computing; and
a result retaining unit (44) which retains an intermediate result of a computing executed by the computing unit (42) in a case where the hardware structure of the computing unit (42) changes, and returns the retained intermediate result to the computing unit (42) in a case where the hardware structure of the computing unit (42) returns to an original state.

The plurality of data modules may include a first data module which represents a first hardware structure for executing a first computing, and a second data module which represents a second hardware structure for executing a second computing which is executed during the first computing.

The first data module may contain call data for calling the second data module in the middle of the first computing.

The computing system may further comprise:
a detection unit (43) which detects the call data contained in the first data module which is loaded; and
a controller (46) which stores an intermediate result of the first computing executed by the computing unit (42) in the result retaining unit (44), and controls the loader (3) to load the second data module, in a case where the detection unit (43) detects the call data.

In a case where the computing unit (42) completes the second computing, the controller (46) may control the loader (3) to load the first data module, and control the computing unit (42) to resume the first computing by returning the intermediate result stored in the result retaining unit (44) to the computing unit (42).

The computing system may further comprise an argument supply unit (45) which supplies a part of the intermediate result of the first computing to the computing unit (42) as an argument for executing the second computing, and supplies an execution result of the second computing to the computing unit (42) as an argument for resuming the first computing.

The result retaining unit (44) may comprise a memory which stores an intermediate result in accordance with a First-In-Last-Out method.

The computing unit (42) may comprise a plurality of gate circuits.

Connection between the plurality of gate circuits may be switched in accordance with a loaded data module.

The computing system may be connectable to another computing system which has a hardware structure changeable in accordance with a hardware structure represented by a supplied data module, and executes a predetermined computing.

The computing system may further comprise a result acquiring unit (7) which supplies the second data module which is loaded, to another computing system in order to control another computing system to execute the second computing, and acquires an execution result of the second computing from another computing system, in a case where the computing system is connected to another computing system.

The computing unit (42) may supply the second data module which is loaded, to the result acquiring unit (7), and stop execution of the first computing, in a case where the computing system is connected to another computing system.

The result acquiring unit (7) may control the computing unit (42) to resume the first computing by supplying the computing unit with the acquired execution result of the second computing as an argument for resuming the first computing.

A computing system according to a third aspect of the present invention comprises:
a loader (3′) which loads a plurality of program modules by each module, each of the plurality of program modules representing a predetermined computing;
an interpreter (47) which interprets an instruction included in a loaded program module, and outputs at least one signal for realizing a hardware structure which corresponds to a computing represented by the loaded program module in accordance with an interpretation result;
a computing unit (42) which has a hardware structure changeable in accordance with the at least one signal output by the interpreter (47), and executes a predetermined computing; and
a result retaining unit (44) which retains an intermediate result of a computing executed by the computing unit (42) in a case where the hardware structure of the computing unit (42) changes, and recovers the computing unit as it was before the hardware structure of the computing unit (42) changed, by returning the retained intermediate result to the computing unit (42), in a case where the hardware structure returns to an original structure.

The plurality of program modules may include a first program module representing a first computing, and a second program module representing a second computing which is executed during the first computing.

The first program module may contain a call instruction for calling the second program module in the middle of the first computing.

The computing system may further comprise a controller (46′) which stores an intermediate result of the first computing executed by the computing unit (42) in the result retaining unit (44), and controls the loader (3′) to load the second program module, in a case where the interpreter (47) interprets the call instruction.

In a case where the computing unit (42) completes the second computing, the controller (46′) may control the loader (3′) to load the first program module, and control the computing unit (42) to resume the first computing by returning the intermediate result stored in the result retaining unit (44) to the computing unit (42).

The computing system may further comprise an argument supply unit (45) which supplies a part of the intermediate result of the first computing to the computing unit (42) as an argument for executing the second computing, and supplies an execution result of the second computing to the computing unit (42) as an argument for resuming the first computing.

The result retaining unit (44) may comprise a memory which stores an intermediate result in accordance with a First-In-Last-Out method.

The computing unit (42) may comprise a plurality of gate circuits.

Connection between the plurality of gate circuits may be switched in accordance with at least one signal supplied from the interpreter.

The computing system may be connectable to another computing system which has a hardware structure changeable in accordance with a computing represented by a program module which is supplied, and executes the computing represented by the supplied program module.

The computing system may further comprise a result acquiring unit (7) which supplies the second program module which is loaded, to another computing system in order to control another computing system to execute the second computing, and acquires an execution result of the second computing from another computing system, in a case where the computing system is connected to another computing system.

The interpreter (47) may supply the second program module which is loaded, to the result acquiring unit (7), in a case where the computing system is connected to another computing system.

The result acquiring unit (7) may control the computing unit to continue the first computing, by supplying the computing unit (42) with the acquired execution result of the second computing as an argument for resuming the first computing.

### BRIEF DESCRIPTION OF DRAWINGS

FIG. 1 is a diagram showing a structure of a computing system according to a first embodiment.

FIG. 2 is a diagram showing an example of a computing executed by the computing system shown in FIG. 1.

FIG. 3 is a diagram showing a structure of a computing system according to a second embodiment.

FIG. 4 is a diagram showing another example of a structure of a computing system.

FIG. 5 is a diagram showing an example in which another computing system is connected to the computing system shown in FIG. 4.

FIG. 6 is a diagram showing another example of a structure of a computing system.

### BEST MODE FOR CARRYING OUT THE INVENTION

### First Embodiment

A computing system according to a first embodiment of the present invention will now be explained with reference to the drawings.

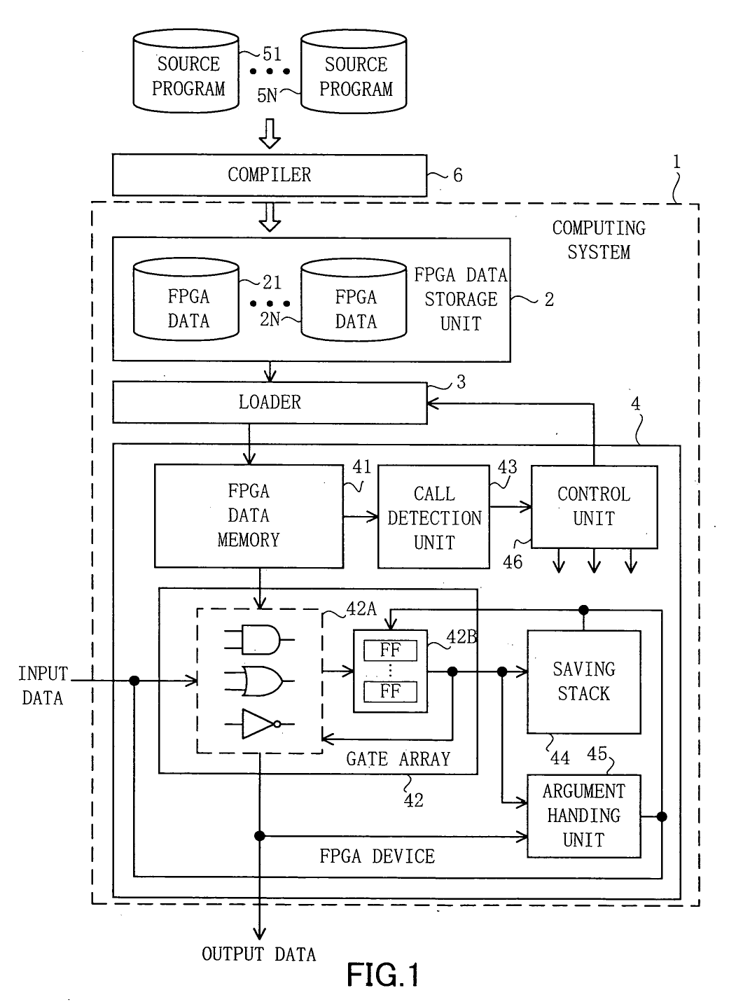

As shown in FIG. 1, a computing system 1 according to the first embodiment comprises an FPGA data storage unit 2, a loader 3, and an FPGA device 4.

The FPGA data storage unit 2 stores a plurality of data modules (FPGA data 21 to 2N).

A compiler 6 compiles a plurality of program modules (source programs 51 to 5N), and thus, the FPGA data 21 to 2N are generated. Each of the source programs 51 to 5N is described in a program language which can express a structure of hardware, and represents a computing to be executed by the computing system 1. The FPGA data 21 to 2N represent hardware structures which are the most suitable for executing computing represented by the source programs 51 to 5N.

At least one of the source programs 51 to 5N contains a function for calling other program modules. That is, at least one of the FPGA data 21 to 2N contains call data for calling other data modules.

The loader 3 comprises a logic circuit or the like, and loads the FPGA data 21 to 2N stored in the FPGA data storage unit 2 into the FPGA device 4 by module unit at an appropriate timing. Specifically, the loader 3 loads a data module generated from a program module which represents a computing which is the target of execution, that is, a data module corresponding to a computing which is the target of execution, into the FPGA device 4. An instruction for loading a data module is given from outside at the time the computing is started, and other than this, may be given in accordance with execution of a computing by the FPGA device 4.

The FPGA device 4 has a hardware structure which is represented by a data module loaded by the loader 3, and applies a computing corresponding to the loaded data module to input data supplied from outside. Then, the FPGA device 4 outputs a result of the computing to outside as output data.

Specifically, the FPGA device 4 comprises an FPGA data memory 41, a gate array 42, a call detection unit 43, a saving stack 44, an argument handing unit 45, and a control unit 46. The call detection unit 43, the saving stack 44, the argument handing unit 45, and the control unit 46 are constituted by a logic circuit or the like.

The FPGA data memory 41 is constituted by a RAM (Random Access Memory), and stores a data module loaded by the loader 3.

The gate array 42 comprises a computing unit 42A which is constituted by a plurality of gate circuits such as AND, OR, and NOT, and a state retaining unit 42B which is constituted by a plurality of flip flops (FF).

The computing unit 42A has a hardware structure represented by a loaded data module, that is, a hardware structure which is most suitable for executing a computing which is the target of execution. Specifically, connection between the gate circuits which constitute the computing unit 42A is switched in accordance with a loaded data module. Due to this, the hardware structure of the computing unit 42A becomes the structure designated by the loaded data module. And by having the hardware structure designated by the loaded data module, the computing unit 42A can execute the computing which corresponds to the loaded data module at high speed.

The state retaining unit 42B retains an intermediate result (internal state) of a computing executed by the computing unit 42A. Each flip flop constituting the state retaining unit 42B can accept data which is written from outside.

The call detection unit 43 detects call data for calling another data module, which is contained in a loaded data module.

The saving stack 44 is used, in a case where the call detection unit 43 detects call data, for saving in accordance with a FILO (First-In-Last-Out) method, data (intermediate result) retained by the state retaining unit 42B, and identification data for identifying the data module which calls another data module (that is, the data module which contains the call data).

The argument handing unit 45 hands over an argument between a data module which calls another data module (referred to as caller data module), and a data module which is called, when the data module to be called is actually called, and when the the caller data module returns to the FPGA data memory 41.

Specifically, when a data module is called, the argument handing unit 45 retains data, among data retained by the plurality of flip flops of the state retaining unit 42B, that is used in executing a computing which corresponds to the called data module. Then, the argument handing unit 45 gives the retained data to the gate array 42 as an input (argument) of the computing that corresponds to the called data module. And when the caller data module is loaded again, the argument handing unit 45 retains data retained by the plurality of flip flops of the state retaining unit 42B, that is, a result (return value) of the computing which corresponds to the called data module. Then, the argument handing unit 45 writes the retained result to a predetermined flip flop which constitutes the state retaining unit 42B.

The control unit 46 controls an intermediate result of a computing which corresponds to a caller data module together with identification information of the caller data module to be saved in the saving stack 44 when a data module is called by the caller data module. And at the same time, the control unit 46 temporarily stores data among data retained by the state retaining unit 42B, that is used when executing a computing which corresponds to the called data module in the argument handing unit 45. Then, the control unit 46 controls the loader 3 to load the called data module in the FPGA data memory 41. Then, the control unit 46 gives the data stored in the argument handing unit 45 to the gate array 42 as input data.

When the computing which corresponds to the called data module is completed, the control unit 46 temporarily stores a result (output data) of the computing in the argument handing unit 45. Then, the control unit 46 controls the loader 3 to load the caller data module which is identified by identification data saved in the saving stack 44, in the FPGA data memory 41. Then, the control unit 46 controls the data (intermediate result) which has been saved in the saving stack 44 to return to the state retaining unit 42B, and writes the result (output data) temporarily stored in the argument handing unit 45, to a predetermined flip flop which constitutes the state retaining unit 42B.

Input data which is input to the FPGA device 4 from outside may be data input by an input device such as a keyboard, and may also be data read out from an external storage device such as a magnetic disk device. Output data which is output from the FPGA device 4 to outside may be output by an output device such as a display device, and may also be written to an external storage device, and further may be control data for controlling a peripheral device.

An operation of the computing system 1 according to the first embodiment will be explained.

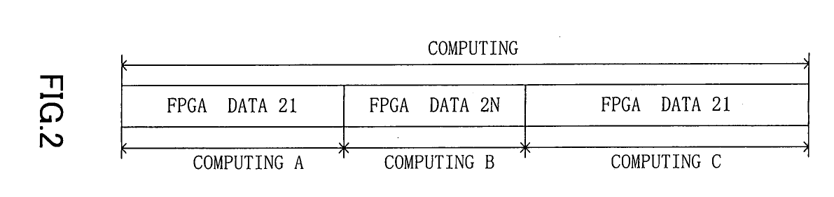

A case where the computing system 1 executes a computing shown in FIG. 2 will be explained below as an example.

As shown in FIG. 2, FPGA data 21 is loaded first, then, the FPGA data 21 calls FPGA data 2N, and after this, the FPGA data 21 returns.

The entire computing consists of a computing A, a computing B, and a computing C, as shown in FIG. 2. The computing A corresponds to the FPGA data 21, and constitutes a part before the computing B which corresponds to the FPGA data 2N becomes necessary. The computing C corresponds to the FPGA data 21, and constitutes a part which is executed using a result of the computing B.

First, the loader 3 loads the FPGA data 21 into the FPGA data memory 41 in accordance with a load instruction supplied from outside. Due to this, signals having a level corresponding to the FPGA data 21 are input to the computing unit 42A.

Connection between the gate circuits which constitute the computing unit 42A is switched in accordance with the input signals, so that the hardware structure of the computing unit 42A becomes the structure designated by the FPGA data 21. Due to this, the computing unit 42A becomes able to execute the computing A which corresponds to the FPGA data 21.

When input data is supplied to the gate-array 42 from outside, the computing unit 42A applies the computing A to the supplied input data.

The call detection unit 43 detects call data contained in the loaded FPGA data 21, and outputs a detection signal representing that call data is detected, to the control unit 46.

The control unit 46 controls a computing result (intermediate result) obtained at the time the computing A is completed, to be saved in the saving stack 44 in response to the detection signal supplied from the call detection unit 43. Specifically, the control unit 46 controls data (internal state of the gate array 42) which is retained by the state retaining unit 42B together with identification data of the FPGA data 21 which is the caller data module, to be saved in the topmost level of the saving stack 44.

And the control unit 46 temporarily stores data among data retained by the state retaining unit 42B, that is used in the computing B, in the argument handing unit 45.

Thereafter, the control unit 46 controls the loader 3 to load the FPGA data 2N which is the called data module into the FPGA data memory 41. Thus, signals having a level corresponding to the FPGA data 2N is input to the computing unit 42A.

Connection between the gate circuits which constitute the computing unit 42A is switched in accordance with the input signals, so that the hardware structure of the computing unit 42A becomes the structure designated by the FPGA data 2N. Due to this, the computing unit 42A becomes able to execute the computing B which corresponds to the FPGA data 2N.

The control unit 46 inputs the data which is temporarily stored in the argument handing unit 45 to the gate array 42 as input data. Thus, the computing unit 42A executes the computing B.

When the computing B is completed, the control unit 46 temporarily stores output data from the gate array 42 in the argument handing unit 45 as an argument to be handed to the caller FPGA data 21.

Then, the control unit 46 refers to the identification data which is saved in the topmost level of the saving stack 44, and identifies the FPGA data 21 which is the caller data.

The control unit 46 controls the loader 3 to reload the FPGA data 21 to the FPGA data memory 41. Thus, the hardware structure of the computing unit 42A switches from the structure designated by the FPGA data 2N to the structure designated by the FPGA data 21, in the same way as described above.

When the caller FPGA data 21 is reloaded, the control unit 46 writes back the data (internal state) which is located in the topmost level of the saving stack 44, to each flip flop of the state retaining unit 42B. Thus, the internal state of the gate array 42 returns to the original state.

Further, the control unit 46 writes the data temporarily stored in the argument handing unit 45 to a predetermined flip flop which constitutes the state retaining unit 42B.

In this state, the computing unit 42A starts the computing C which corresponds to the FPGA data 21, and outputs a final computing result as output data.

The FPGA data 2N which is called by the FPGA data 21 may call another data module. In this case, the call detection unit 43 may detect call data contained in the FPGA data 2N, and output a detection signal representing that call data is detected, to the control unit 46, in the same way as described above. Then, the control unit 46 may perform the same control as described above in accordance with the supplied detection signal. With this operation, a large-scale computing represented by three or more program modules can be executed.

As explained above, the hardware structure of the computing unit 42A switches to a structure designated by a loaded data module, that is a structure most suitable for executing a computing which is the target of execution. Due to this, a computing can be executed at higher speed than in a case where a CPU reads a program and executes a computing.

And by saving an intermediate result of a computing corresponding to a caller data module in a saving stack, the computing which corresponds to the caller data module can be resumed after a computing corresponding to the called data module is completed. Due to this, a large-scale computing represented by a plurality of program modules can be executed.

The computing system 1 can execute a computing represented by a large-scale program which consists of a plurality of program modules. Therefore, a program can be divided into a plurality of program modules in order to create a program by each program module, or each program module can be used as a part when creating another program. As a result, creation of a program can be realized in a short period of time.

### Second Embodiment

A computing system according to a second embodiment of the present invention will now be explained with reference to the drawings.

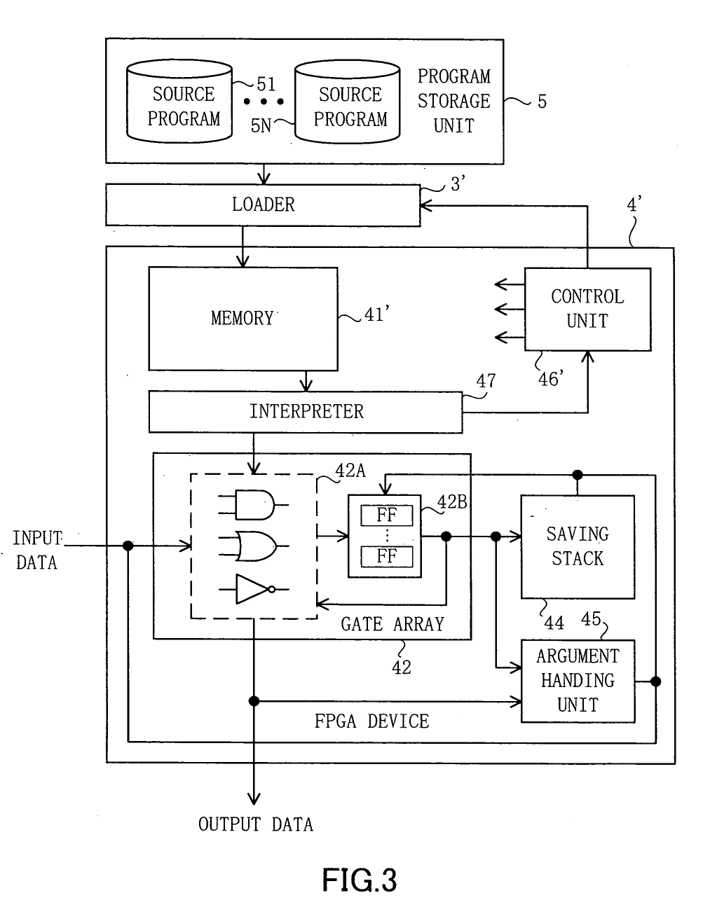

FIG. 3 shows a structure of a computing system according to the second embodiment.

A computing system according to the second embodiment does not compile a plurality of program modules (source program 51 to 5N), but loads the program modules directly to a FPGA device 4′.

As shown in FIG. 3, the computing system according to the second embodiment comprises a loader 3′, the FPGA device 4′, and a program storage unit 5.

The loader 3′ loads the source programs 51 to 5N stored in the program storage unit 5 into the FPGA device 4′ by each module at a predetermined timing in accordance with an instruction of a control unit 46′.

As shown in FIG. 3, the FPGA device 4′ comprises a memory 41′, a gate array 42, a saving stack 44, an argument handing unit 45, the control unit 46′, and an interpreter 47.

The memory 41′ is constituted by a RAM, and stores a program module loaded by the loader 3′.

The interpreter 47 sequentially interprets instructions contained in the program module loaded in the memory 41′ one by one. Then, the interpreter 47 outputs signals for realizing a hardware structure which is the most suitable for executing a computing which is designated by the loaded program module, to a computing unit 42A of the gate array 42 in accordance with the interpretation result.

Connection between gate circuits which constitute the computing unit 42A is switched in accordance with the signal supplied from the interpreter 47. Due to this, the hardware structure of the computing unit 42A becomes the structure which is the most suitable for executing a computing which is designated by the loaded program module, that is, the structure that corresponds to a computing which is the target of execution.

And in a case where an interpreted instruction is an instruction for calling another program module, the interpreter 47 outputs a call signal representing that another program module should be called, to the control unit 46′.

In a case where supplied with a call signal from the interpreter 47, the control unit 46′ controls an internal state of the gate array 42 together with identification data for identifying the caller program module, to be saved in the saving stack 44.

Then, the control unit 46′ temporarily stores data among data stored in flip flops of a state retaining unit 42B, that is used in executing a computing represented by the called program module, in the argument handing unit 45.

Then, the control unit 46′ controls the loader 3′ to load the called program module.

Afterwards, the control unit 46′ gives the data temporarily stored in the argument handing unit 45 to the gate array 42 as input data.

When the computing corresponding to the called program module is completed, the control unit 46′ temporarily stores the computing result (output data) in the argument handing unit 45.

Then, the control unit 46′ controls the loader 3′ to load the caller program module which is identified by the identification data saved in the saving stack 44, in the memory 41′.

Then, the control unit 46′ returns the internal state saved in the saving stack 44 to the state retaining unit 42B, and writes the output data (argument) which is temporarily stored in the argument handing unit 45, to a predetermined flip flop which constitutes the state retaining unit 42B. Thus, the computing represented by the caller program module is resumed.

The interpreter 47 may be constituted by a plurality of gate circuits. With such constitution, the interpreter 47 can output signals having a level corresponding to a result of interpreting a loaded program module, at high speed. As a result, the hardware structure of the computing unit 42A can be switched at such high speed as to give almost no influence on the speed of executing a computing.

Since the FPGA device 4′ comprises the interpreter 47 as described above, the source programs 51 to 5N can be loaded into the FPGA device 4′ by each module. Due to this, a large-scale computing represented by a plurality of program modules can be executed at high speed even without a compiler which suits the structure of the FPGA device 4′.

A plurality of hardware structures may be required for executing a computing represented by one program module. In this case, the control unit 46′ controls data (intermediate result) which is obtained immediately before the hardware structure is switched, to be saved in the saving stack 44, just as described above. Thereafter, the interpreter 47 inputs signals having a predetermined level to the computing unit 42A, and thereby the hardware structure of the computing unit 42A can be switched in the middle of the computing.

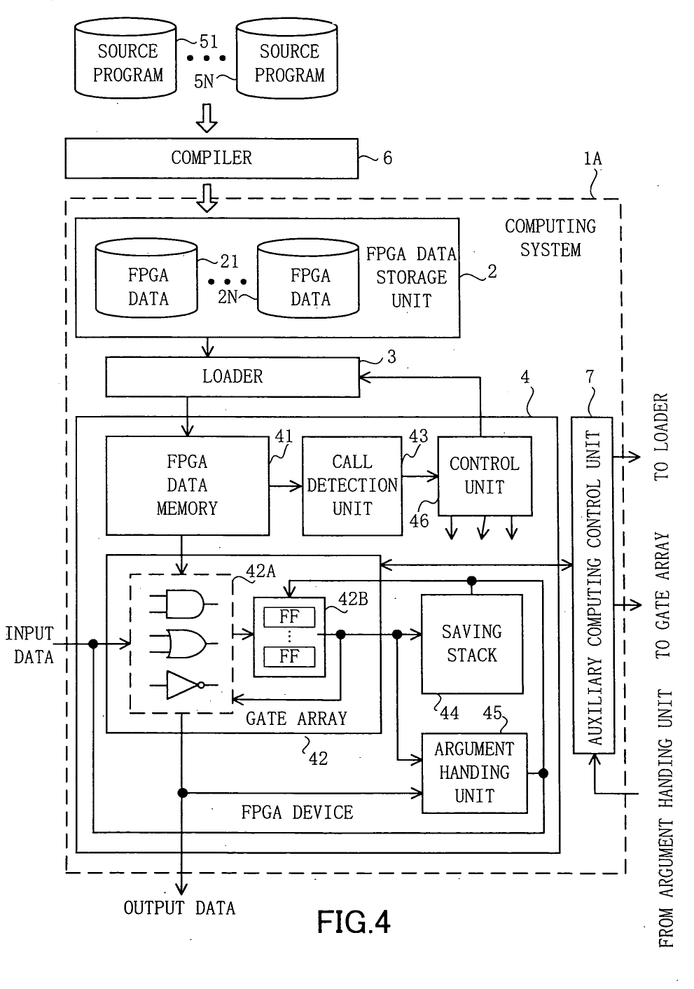

And as shown in FIG. 4 for example, an auxiliary computing control unit 7 which is constituted by a logic circuit, or the like may be added to the structure of the computing system 1 shown in the first embodiment. Another computing system can be connected to a computing system 1A having such a structure.

For example, in a case where another computing system having the structure shown in FIG. 1 or FIG. 4 is connected to the computing system 1A, the auxiliary computing control unit 7 is detachably connected to the loader 3, gate array 42, and argument handing unit 45 of another computing system.

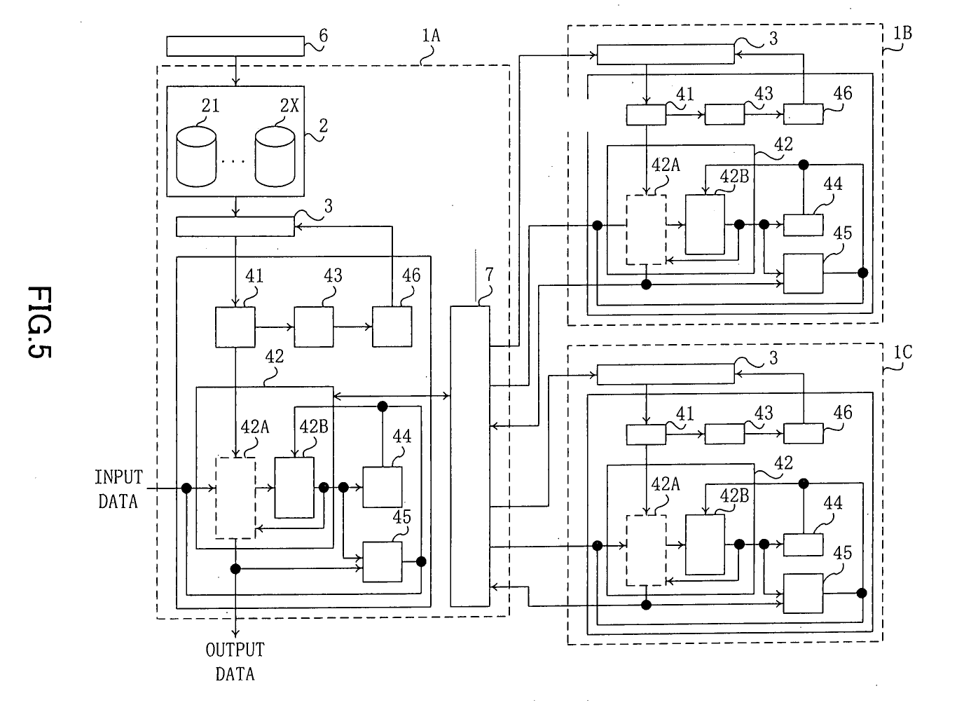

Further, as shown in FIG. 5 for example, two computing systems 1B and 1C may be connected to the computing system 1A. The computing systems 1B and 1C have structures which are substantially the same as the structure shown in FIG. 1, for example. In this case, the auxiliary computing control unit 7 of the computing system 1A is connected to the loaders 3, gate arrays 42, and argument handing units 45 of the computing systems 1B and 1C, respectively. However, the computing systems 1B and 1C may not necessarily require the FPGA data storage unit 2.

Hereinafter, an operation performed when the computing system 1A controls the computing systems 1B and 1C to execute parallel operations, will be explained.

It is assumed that FPGA data 21 is loaded first, and the FPGA data 21 calls FPGA data 2X. And it is also assumed that the computing system 1A controls the computing systems 1B and 1C to load the FPGA data 2X.

First, the loader 3 of the computing system 1A loads the FPGA data 21 into the FPGA data memory 41. Thus, the hardware structure of the computing unit 42A becomes the structure designated by the FPGA data 21, in the same way as described in the first embodiment.

Then, when input data is input to the gate array 42 of the computing system 1A from outside, the computing unit 42A of the computing system 1A executes a computing corresponding to the FPGA data 21.

The call detection unit 43 of the computing system 1A detects call data which instructs calling of the FPGA data 2X, and contained in the loaded FPGA data 21. Then, the call detection unit 43 outputs a detection signal representing that the call data is detected, to the control unit 46.

The control unit 46 of the computing system 1A controls the loader 3 of the computing system 1A to load the FPGA data 2X which is the called data module into the FPGA data memory 41, when supplied with the detection signal from the call detection unit 43.

When the FPGA data 2X is loaded, the gate array 42 of the computing system 1A acquires the loaded FPGA data 2X, as part of the process (computing) corresponding to the FPGA data 21.

Then, the gate array 42 supplies the acquired FPGA data 2X to the auxiliary computing control unit 7, and stops executing the computing which corresponds to the FPGA data 21.

The control unit 46 of the computing system 1A supplies data (arguments) among data retained by the state retaining unit 42B of the computing system 1A, that are necessary for executing a computing which corresponds to the FPGA data 2X, to the auxiliary computing control unit 7.

The auxiliary computing control unit 7 controls the loaders 3 of the computing systems 1B and 1C to load the supplied FPGA data 2X into the FPGA data memories 41 of the computing systems 1B and 1C. As a result, the hardware structures of the computing units 42A of the computing systems 1B and 1C becomes the structure designated by the FPGA data 2X.

Then, the auxiliary computing control unit 7 of the computing system 1A inputs arguments out of the supplied arguments, that are to be supplied to the computing system 1B, to the gate array 42 of the computing system 1B as input data, and inputs arguments that are to be supplied to the computing system 1C, to the gate array 42 of the computing system 1C as input data. As a result, the gate arrays 42 of the computing systems 1B and 1C respectively execute the computing that corresponds to the FPGA data 2X.

When the computing corresponding to the FPGA data 2X is completed, the control unit 46 of the computing system 1B (or 1C) temporarily stores output data from the gate array 42 of the computing system 1B (or 1C), in the argument handing unit 45 of the computing system 1B (or 1C), as an argument to be used for resuming the computing which corresponds to the FPGA data 21 which is the caller data module.

The auxiliary computing control unit 7 of the computing system 1A controls the argument handing units 45 of the computing systems 1B and 1C, and when detecting that the output data is temporarily stored in those argument handing units 45, acquires the stored output data from the respective argument handing units 45.

Then, the auxiliary computing control unit 7 of the computing system 1A writes the acquired output data to predetermined flip flops which constitute the state retaining unit 42B of the computing system 1A.

In this state, the gate array 42 of the computing system 1A resumes the computing which corresponds to the FPGA data 21. As a result, a final computing result is output as output data.

As described above, if the computing system has the structure shown in FIG. 4, another computing system can be added if necessary. Due to this, a complicated computing which cannot be completed in a short period of time by a single computing system, and a computing which requires a parallel operation can be completed in a short period of time.

And in a case where another computing system to be connected to the computing system 1A has the structure shown in FIG. 4, still another computing system can be connected to the “another” computing system. Due to this, the “another” computing system can control the “still another” computing system connected thereto to execute a computing, and can acquire the computing result, in the same way as described above.

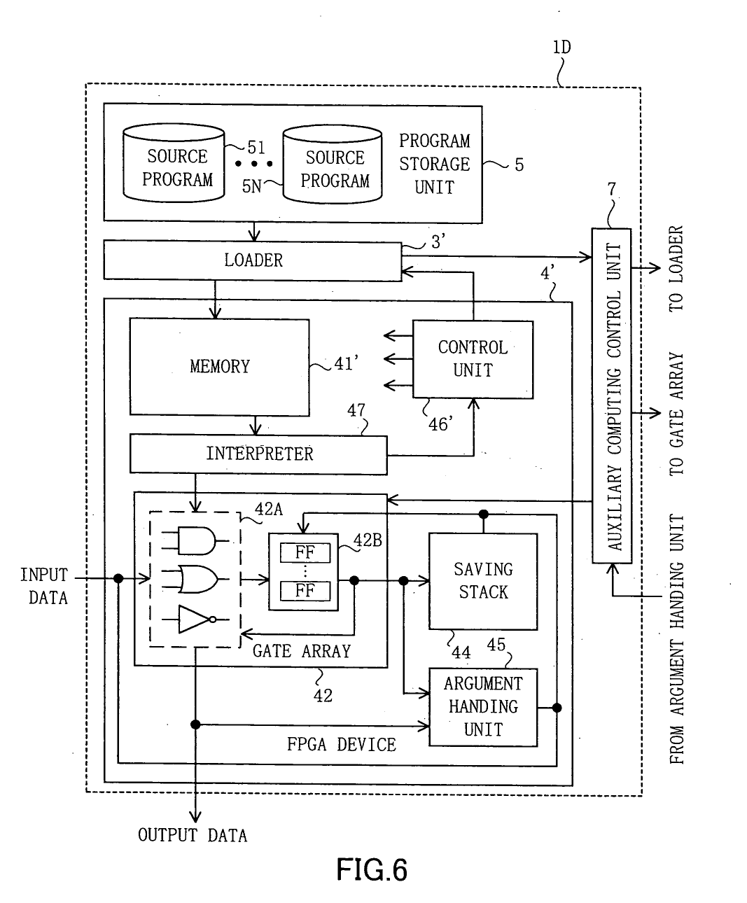

Further, as shown in FIG. 6 for example, the above described auxiliary computing control unit 7 may be added to the computing system shown in FIG. 3. Then, a computing system ID shown in FIG. 6 may control another computing system connected to the computing system 1D to execute a computing represented by a loaded program module.

In this case, if an instruction interpreted by the interpreter 47 of the computing system 1D is an instruction for calling another program module, the interpreter 47 may supply the called program module which is loaded, to the auxiliary computing control unit 7. The auxiliary computing control unit 7 may supply the supplied program module to another computing system, and may control another computing system to execute a computing. Then, the auxiliary computing control unit 7 may acquire a computing result from another computing system, and may supply the computing result to the gate array 42, so that the computing represented by the caller program module can be resumed.

However, in this case, another computing system which is connected to the computing system 1D should have the structure shown in FIG. 3, for example.

In the above described embodiment, the loader 3 loads one of the FPGA data 21 to 2N stored in the FPGA data storage unit 2, directly to the FPGA data memory 41. In contrast, the FPGA data 21 to 2N may include a macro. The FPGA data storage unit 2 may store macro data, and the loader 3 may perform macro call over the FPGA data 21 to 2N, when loading the FPGA data 21 to 2N into the FPGA data memory 41.

Various embodiments and changes may be made thereonto without departing from the broad spirit and scope of the invention. The above described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Application No. 2001-139951 filed on May 10, 2001 and Japanese Patent Application No. 2002-60515 filed on Mar. 6, 2002, and including specifications, claims, drawings and summaries. The disclosure of the above Japanese Patent Applications is incorporated herein by reference in its entirety.

1. A computing system, comprising:
a computing unit (42) which has a hardware structure corresponding to a computing which is a target of execution, and executes the computing which is the target of execution;
a state memory (44) which stores an internal state of said computing unit; and
a controller (46, 46′) which controls the internal state of said computing unit,
wherein: said computing unit (42) executes a second computing in the middle of a first computing; and
said controller (46, 46′) stores the internal state in said state memory (44) when a computing to be executed by said computing unit (42) switches from the first computing to the second computing, and controls said computing unit (42) to resume execution of the first computing by returning the internal state stored in said state memory (44) to said computing unit (42) when a computing to be executed by said computing unit (42) returns from the second computing to the first computing.

2. The computing system according to claim 1, wherein
said state memory (44) stores the internal state in accordance with a First-In-Last-Out method.

3. The computing system according to claim 1, wherein:
said computing unit (42) comprises a plurality of gate circuits; and
connection between said plurality of gate circuits is switched in accordance with a computing which is a target of execution.

4. A computing system, comprising:
a loader (3) which loads a plurality of data modules by each module, each of the plurality of data modules representing a hardware structure which is suitable for executing a predetermined computing;
a computing unit (42) which has a hardware structure changeable in accordance with a hardware structure represented by a loaded data module, and executes a predetermined computing; and
a result retaining unit (44) which retains an intermediate result of a computing executed by said computing unit (42) in a case where the hardware structure of said computing unit (42) changes, and returns the retained intermediate result to said computing unit (42) in a case where the hardware structure of said computing unit (42) returns to an original state.

5. The computing system according to claim 4, wherein:
the plurality of data modules include a first data module which represents a first hardware structure for executing a first computing, and a second data module which represents a second hardware structure for executing a second computing which is executed during the first computing;
the first data module contains call data for calling the second data module in the middle of the first computing; and
said computing system further comprises:
a detection unit (43) which detects the call data contained in the first data module which is loaded; and
a controller (46) which stores an intermediate result of the first computing executed by said computing unit (42) in said result retaining unit (44), and controls said loader (3) to load the second data module, in a case where said detection unit (43) detects the call data.

6. The computing system according to claim 5, wherein
in a case where said computing unit (42) completes the second computing, aid controller (46) controls said loader (3) to load the first data module, and controls said computing unit (42) to resume the first computing by returning the intermediate result stored in said result retaining unit (44) to said computing unit (42).

7. The computing system according to claim 6, further comprising
an argument supply unit (45) which supplies a part of the intermediate result of the first computing to said computing unit (42) as an argument for executing the second computing, and supplies an execution result of the second computing to said computing unit (42) as an argument for resuming the first computing.

8. The computing system according to claim 7, wherein
said result retaining unit (44) comprises a memory which stores an intermediate result in accordance with a First-In-Last-Out method.

9. The computing system according to claim 7, wherein:
said computing unit (42) comprises a plurality of gate circuits; and
connection between said plurality of gate circuits is switched in accordance with a loaded data module.

10. The computing system according to claim 5, wherein:
said computing system is connectable to another computing system which has a hardware structure changeable in accordance with a hardware structure represented by a supplied data module, and executes a predetermined computing; and
said computing system further comprises a result acquiring unit (7) which supplies the second data module which is loaded, to another computing system in order to control another computing system to execute the second computing, and acquires an execution result of the second computing from another computing system, in a case where said computing system is connected to another computing system.

11. The computing system according to claim 10, wherein:
said computing unit (42) supplies the second data module which is loaded, to said result acquiring unit (7), and stops execution of the first computing, in a case where said computing system is connected to another computing system; and
said result acquiring unit (7) controls said computing unit (42) to resume the first computing by supplying said computing unit with the acquired execution result of the second computing as an argument for resuming the first computing.

12. A computing system, comprising:
a loader (3′) which loads a plurality of program modules by each module, each of the plurality of program modules representing a predetermined computing;
an interpreter (47) which interprets an instruction included in a loaded program module, and outputs at least one signal for realizing a hardware structure which corresponds to a computing represented by the loaded program module in accordance with an interpretation result;
a computing unit (42) which has a hardware structure changeable in accordance with the at least one signal output by said interpreter (47), and executes a predetermined computing; and
a result retaining unit (44) which retains an intermediate result of a computing executed by said computing unit (42) in a case where the hardware structure of said computing unit (42) changes, and recovers said computing unit as it was before the hardware structure of said computing unit (42) changed, by returning the retained intermediate result to said computing unit (42), in a case where the hardware structure returns to an original structure.

13. The computing system according to claim 12, wherein:
the plurality of program modules include a first program module representing a first computing, and a second program module representing a second computing which is executed during the first computing;
the first program module contains a call instruction for calling the second program module in the middle of the first computing; and
said computing system further comprises a controller (46′) which stores an intermediate result of the first computing executed by said computing unit (42) in said result retaining unit (44), and controls said loader (3′) to load the second program module, in a case where said interpreter (47) interprets the call instruction.

14. The computing system according to claim 13, wherein
in a case where said computing unit (42) completes the second computing, said controller (46′) controls said loader (3′) to load the first program module, and controls said computing unit (42) to resume the first computing by returning the intermediate result stored in said result retaining unit (44) to said computing unit (42).

15. The computing system according to claim 14, further comprising
an argument supply unit (45) which supplies a part of the intermediate result of the first computing to said computing unit (42) as an argument for executing the second computing, and supplies an execution result of the second computing to said computing unit (42) as an argument for resuming the first computing.

16. The computing system according to claim 15, wherein
said result retaining unit (44) comprises a memory which stores an intermediate result in accordance with a First-In-Last-Out method.

17. The computing system according to claim 15, wherein:
said computing unit (42) comprises a plurality of gate circuits; and
connection between said plurality of gate circuits is switched in accordance with at least one signal supplied from said interpreter.

18. The computing system according to claim 13, wherein
said computing system is connectable to another computing system which has a hardware structure changeable in accordance with a computing represented by a program module which is supplied, and executes the computing represented by the supplied program module; and
said computing system further comprises a result acquiring unit (7) which supplies the second program module which is loaded, to another computing system in order to control another computing system to execute the second computing, and acquires an execution result of the second computing from another computing system, in a case where said computing system is connected to another computing system.

19. The computing system according to claim 18, wherein:
said interpreter (47) supplies the second program module which is loaded, to said result acquiring unit (7), in a case where said computing system is connected to another computing system; and
said result acquiring unit (7) controls said computing unit to continue the first computing, by supplying said computing unit (42) with the acquired execution result of the second computing as an argument for resuming the first computing.
